(19) United States
(12) Patent Application Publication
(10) Pub. No.: US 2018/0081512 A1
(43) Pub. Date: Mar. 22, 2018

(54) SYSTEM AND METHOD FOR DELIVERING ELECTRONIC PUBLICATIONS SUPPLEMENTED WITH ON-DEMAND CONTENT

(71) Applicant: Khaleb Cyril, Hamden, CT (US)

(72) Inventor: Khaleb Cyril, Hamden, CT (US)

(21) Appl. No.: 15/272,347

(22) Filed: Sep. 21, 2016

(51) Int. Cl. G06F 3/0483; G06F 17/30; G06F 17/21; G06F 3/0482

(52) U.S. Cl. CPC G06F 3/0483; G06F 17/30882; G06F 17/2705; G06F 17/212; G06F 3/0482; G06F 17/30675

(57) ABSTRACT

Disclosed is a system for overlaying content on an electronic publication. The system comprises a main database comprising a plurality of electronic publications listed therewithin, each electronic publication comprising a multiplicity of selectable words, each of which associated with a supplemental section, a user interface for enabling the selection and display of an electronic publication, an input module for receiving at least one selectable word selected via the user interface, a parsing module for parsing each of the at least one supplemental database for a match against each of the at least one selectable word, a retrieval module for, upon match, retrieving a supplemental section from each of the at least one supplemental database and a display module for displaying the retrieved supplemental section or sections within the electronic publication.

### BACKGROUND

The present disclosure relates to computer-implemented systems and methods that deliver electronic textual publications especially pertaining to an academic curriculum and more particularly, to such a system and a method that supplements said electronic publications with on-demand content for easier understanding thereof.

It is very commonplace for e-book readers to have dictionaries built into them. The dictionary could be a simple English language dictionary or may be an advanced one that encompasses specialized terms in the field of medicine, law, engineering, etc. Therefore, a user, while reading an electronic publication such as an e-textbook, upon encountering an unknown scientific term, simply has to select the same by double tapping, dragging-and-dropping, long-pressing, or the like, resulting in activating the dictionary, which fetches the meaning of the term without the user ever having to leave the e-book app. However, as the meanings or definitions of scientific terminology are not as easy to understand as the non-scientific English words, many a time, a user, in spite of having the dictionary at his or her disposal, tends leave the e-book app looking for information that helps him understand the term better. For example, said situation arises when the definition for a scientific term may include several other scientific terms, the meaning of which needs to be looked up as well. Since an e-textbook usually has many such complicated scientific terms, the user might find himself or herself constantly looking elsewhere for information as the information provided by the inbuilt dictionary is not readily understandable. Although, upon leaving the e-book app, one can get to the meaning by searching the web, given the complicated scientific terminology, this is very likely a time-taking process as web results are usually redundant and unorganized. This is very bothersome especially during exam times as one might have to memorize the definitions of the scientific terms.

In the light of the aforementioned, there is a long-felt need in the art for computer-implemented system and method that delivers content to a user without him or her ever having to leave the e-book app. Secondly, there is a need in the art for said content to be presented in an organized manner.

### SUMMARY

An embodiment of the present invention comprises a computer-implemented system for displaying an electronic publication supplemented with on-demand content for easier understanding. An electronic publication may comprise an e-book, an online article, etc., downloaded onto a user terminal such as, smartphone, tablet, laptop, desktop, etc., over a communication network such as the Internet. The textual content of the electronic publication comprises a multiplicity of words (or scientific terms) that are configured to be selectable.

The system comprises a main database, a plurality of supplemental databases, a user interface, and a processor. The main database comprises a plurality of electronic publications listed therewithin. Each supplemental database comprises a plurality of selectable words listed therewithin. Each selectable word within the supplemental database is associated with a supplemental content section, which comprises material that helps a user in understanding the corresponding selectable word. More particularly, the supplemental section comprises the definition of the selected word, one or more analogies for understanding the selectable word, one or more images representative selectable word, formula or formulae related to the selectable word, one or more graphs representative selectable word, a video or videos related to the selectable word, etc., or a combination thereof. Notably, the textual content of the supplemental section also includes a plurality of selectable words, each of which is again associated with a supplemental section. Each supplemental database is sourced from a third-party member website.

The processor comprises an input module, a parsing module, a retrieval module, a display module and an edit module. The input module, via the user interface, is adapted to receive a selectable word wherein, the selectable word is received by performing actions such as, double-clicking, long-pressing, etc. Upon receiving the selectable word, the parsing module parses each of the plurality of supplemental databases for a match. Upon match, the retrieval module retrieves the matched supplemental sections from all the supplemental databases. At this point, a compound content section, as enabled by the display module, is overlaid on the electronic publication wherein, the compound section comprises a compilation of a few of the supplemental section. Preferably, the at least one supplemental section comprises a few of the retrieved supplemental sections. The user is enabled to repeat the same process for another selectable word within the displayed compound section resulting in another display of a compound section. Notably, in relation to obtaining compound sections by selection of selectable words from the already-displayed compound display sections, the system is configured such that, the process of obtaining compound sections can be performed any number of times on any number of prior compound sections.

The compound section comprises exemplary “next” button, which when selected, displays next few supplemental sections whereby, the user can browse through the meanings/definitions until he/she understands the word. The edit module comprises exemplary at least one “edit” button, each of which is associated with a supplemental section. Selecting an “edit” button allows the user to edit the content of the corresponding supplemental section. The system is configured such that, the edited supplemental section is displayed first within a compound section. In one embodiment, the edit module further comprises an exemplary “add” button associated with each compound section. Selecting the “add” button results in the display of an input field for receiving the user's custom composed supplemental section. The system is configured such that, the added supplemental section is displayed first within a compound section.

Other features and advantages will become apparent from the following description of the preferred embodiments, taken in conjunction with the accompanying drawings.

### BRIEF DESCRIPTION OF THE DRAWINGS

Various embodiments of the disclosed system and method are described herein with reference to the accompanying drawings, which form a part of this disclosure, wherein:

FIG. 1, according to an embodiment of the present invention, is a block diagram of the computer-implemented system.

FIG. 2, according to an embodiment of the present invention, is a block diagram depicting the various components of the processor.

FIG. 3, according to an embodiment of the present invention, is a flowchart of the computer-implemented method.

The various aspects of the present disclosure mentioned above are described in further detail with reference to the aforementioned figures and the following detailed description of exemplary embodiments.

### FIGURES—REFERENCE NUMERALS

10—Main Database
12—User Interface
14—Processor
16—Supplemental Database
18—Communications Network
20—User Terminal
22—Input Module
26—Parsing Module
28—Retrieval Module
30—Display Module
32—Follow Module
34—Rating Module
36—Prioritization Module
38—Edit Module

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

Embodiments of the present invention are directed to a computer-implemented system and method for displaying an electronic publication including on-demand supplementary content. An electronic publication may comprise an e-book, an online article, etc., downloaded onto a user terminal such as, smartphone, tablet, laptop, desktop, etc., over a communication network such as the Internet, Local Area Network (LAN), etc. The content of the electronic publication comprises textual content, imagery, graphical representations, etc. The textual content comprises a multiplicity of words (or terms) that are configured to be selectable, the need for which will become apparent from the following body of text. On the other hand, the “supplemental content,” which, as will be explained in detail in the following body of text, refers to content that is presented in conjunction with the original content of the electronic publication upon demand.

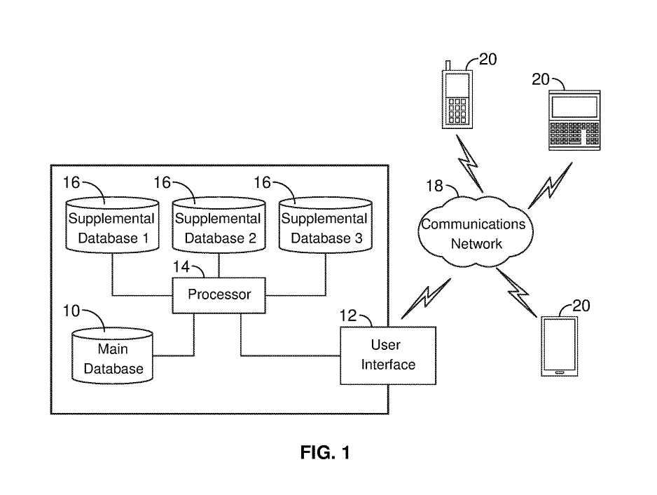

Referring to FIG. 1, the computer-implemented system of the present invention comprises a main database 10, a plurality of supplemental databases 16, a user interface 12, and a processor 14. The main database 10 comprises a plurality of electronic publications listed therewithin. Each supplemental database 16 comprises a plurality of selectable words listed therewithin. More particularly, a selectable word comprises an academic term, specifically pertaining to an educational discipline, which may comprise one of various sciences, such as, mathematics, economics, etc. Each selectable word within the supplemental database is associated with a supplemental content section (hereinafter simply referred to as “supplemental section”). The supplemental section comprises material for helping a user understand the corresponding selectable word. The supplemental section comprises the definition of the selected word, one or more analogies for understanding the selectable word, one or more images representative selectable word, formula or formulae related to the selectable word, one or more graphs representative selectable word, a video or videos related to the selectable word, etc., or a combination thereof. In one embodiment, the system is configured such that, the user is enabled to search for a specific term (by selecting the same) within a field (or discipline) of science. For example, a user, via the user interface 12, is enabled to specify their search like, “nucleus biology function,” “icon computer definition,” etc. The user may also be enabled to search (by selecting) a word by putting noun, verb, etc., next to the word in a search bar when looking for the right definition. After searching, the part of speech could be pasted at the end of the definition in parenthesis. If a word's definition has several parts of speech, the suggestions from the search bar would list them. Notably, the textual content of the supplemental section also includes a plurality of selectable words, each of which is again associated with a supplemental section. Each supplemental database 16 is sourced from a member external source over a communications network 18. More particularly, the external source comprises a third-party website wherefrom the supplemental sections are sourced. The third-party website may comprise any educational or industry website such as, Wikipedia, HowStuffWorks, Coursera, etc. More particularly, the servers of the external third-party websites are integrated with the system whereby, any updation on the third-party servers, if applicable, is reflected in the corresponding supplemental database 16. In one embodiment, at least one of the plurality of supplemental databases 16 comprises an offline database whereby, said offline database is accessible without data connectivity. This also helps in loading the search results quicker. The user interface 12 is provided by a user terminal 20 over a communications network 18.

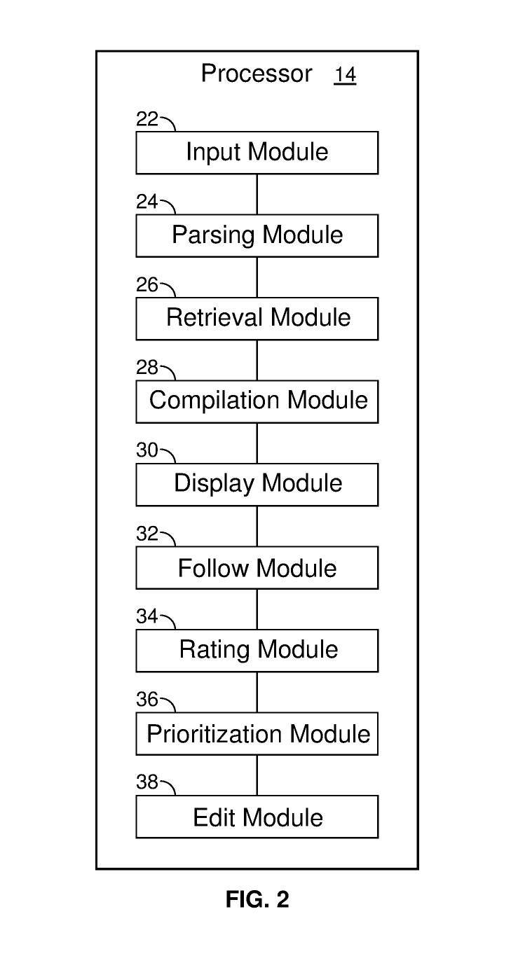

Referring to FIGS. 1 and 2, the processor 14 comprises a plurality of processing modules comprising an input module 22, a parsing module 24, a retrieval module 26, a compilation module 28, a display module 30, a follow module 32, a rating module 34, a prioritization module 36, and an edit module 38 wherein, each of the modules will be explained in the following body of text. The input module 22, via the user interface 12, is adapted to receive one selectable word at a time. More particularly, a selectable word is received upon the selection of the selectable word wherein, the selection is performed by the user by actions such as, double-clicking on the selectable word (in the event of employing a computer mouse in conjunction with the corresponding user terminal 20), long-pressing over the selectable word (in the event of employing a touchscreen in conjunction with the user terminal 20), tapping over the selectable word (in the event of employing a touchscreen in conjunction with the user terminal 20), etc. Upon the reception of the selectable word by the input module 22, the parsing module 24 parses each of the plurality of supplemental database 16 for a match against the selectable word. Upon match, the retrieval module 26 retrieves the matched supplemental sections (associated with the selected selectable word) from all the supplemental databases 16. At this point, a compound content section (referred to as simply “compound section” hereinafter), as enabled by the display module 30, is overlaid on or “popped” over the electronic publication wherein, the compound section comprises a compilation of at least one supplemental section. Notably, the compilation is performed by the compilation module 28. Preferably, the at least one supplemental section comprises a few of the retrieved supplemental sections. Each supplemental section comprises a web-link for directing the user to the reference webpage of the corresponding third-party website. In the embodiment where one or more offline supplemental databases 16 are employed, no reference web-links are provided. Notably, the compound section is displayed closer to the selected selectable word but not obscuring the selected selectable word.

The user is enabled to repeat the same process all over for another selectable word or words within the displayed compound section resulting in another display of an appropriate compound section. Notably, in relation to obtaining compound sections by selection of selectable words from the already-displayed compound display sections, the system is configured such that, the process of obtaining compound sections can be performed any number of times on any number of prior compound sections. The compound sections are displayed such that, they do not obscure each other and the parent selectable word.

Referring to FIGS. 1 and 2, the compound section comprises an exemplary “more” hyperlink or button, which when selected, directs the user to a new tab, pane, page, or the like, whereon the supplemental sections sourced from all the supplemental databases 16 are displayed. The compound section further comprises exemplary “next” and “previous” buttons. Selecting the “next” button displays next few supplemental sections, whereas selecting the “previous” button displays the previous supplemental sections. The edit module 38 comprises exemplary at least one “edit” button, which is a part of the compound section. More particularly, each of the at least one “edit” button is associated with each of the at least one supplemental section. Selecting an “edit” button allows the user to edit the content of the corresponding supplemental section. The edit module further comprises an exemplary “undo” button, which is associated with an edited supplemental section. Selecting the “undo” button results in the reversal of the edited supplemental section to its original content. The system is configured such that, the edited supplemental section is displayed first within a compound section. In one embodiment, the edit module 38 further comprises an exemplary “add” button associated with each compound section. Selecting the “add” button results in the display of an input field for receiving the user's custom composed supplemental section. The system is configured such that, the added supplemental section is displayed first within a compound section. In one embodiment, the processor 14 further comprises a font module (not shown) comprising a list of selectable fonts displayed via the user interface 12. The font module is configured such that, upon selecting a font, the original font of textual content pertaining to the retrieved supplemental sections is changed to the selected font.

Referring to FIGS. 1 and 2, in one embodiment, the edit module 38 further comprises an exemplary “attach” button or an exemplary “paperclip” icon associated with each of the at least one supplemental section. Selecting said button or icon prompts a user to upload an image or a video and associate the uploaded content with the corresponding supplemental section. In one embodiment, the edit module 38 further comprises an exemplary “URL” input field associated with each of the at least one supplemental section. The URL input field is adapted to receive YouTube links therewithin whereby, the corresponding YouTube video is associated with the corresponding supplemental section. In one embodiment, in the event of there being more than one YouTube URL uploads by the user, the user, during later retrieval of the supplemental section, is enabled to filter the search for the more than one YouTube video (associated with the supplemental section) based on the running length thereof.

Referring to FIGS. 1 and 2, the prioritization module 36, as the term suggests, enables prioritization of the supplemental sections within a compound section. Each supplemental section is associated with a plurality of exemplary prioritization buttons or checkboxes wherein, each of which represents a degree of prioritization. For example, the prioritization checkboxes associated with terms “high”, “medium” and “low”. Upon checking a “high” checkbox of a supplemental section, the remaining two checkboxes are rendered non-functional or simply “grayed out.” Further checking a “medium” checkbox of another supplemental section (of the same compound section) grays out the remaining “low” checkbox. The system is configured such that, within a compound section, the supplemental sections are listed according to the degree of priority assigned thereto. Therefore, with respect to the aforementioned example, the supplemental sections marked as “high” priority are listed first, followed by supplemental sections marked as “medium” and “low” priorities. In one embodiment, the prioritization module 36 is configured such that, instead of “high”, “medium” and “low” checkboxes, the supplemental sections are associated with one or more colors, each of which representing a degree of priority. For example, the color red might represent high priority, orange might represent medium priority and yellow, low priority. In one embodiment, the prioritization module 36 is configured such that, upon selecting a color, the corresponding supplemental section is filled therewith making it easier for user-recognition. In one embodiment, the colors are configured to be customizable. In one embodiment, the processor 14 further comprises a favorite module (not shown) instead of the prioritization module 36. The favorite module comprises an exemplary “favorite” button or an exemplary star-shaped icon associated with each of the at least one supplemental section within a compound section. Selecting said icon or button results the corresponding supplemental section being “favorited” whereby, said favorited supplemental section is always displayed first in the corresponding compound section. In one embodiment, in the event of there being only one supplemental section for a selectable word, the functions associated with the corresponding compound and supplemental sections (such as, the “more,” “next,” “previous,” “favorite,” prioritization, etc., buttons, are rendered non-functional or ‘grayed-out.’ In one embodiment, the processor 14 further comprises a history module (not shown) for displaying last-accessed one or more supplemental sections in the current page of the electronic publication. More particularly, the last-accessed supplemental section or sections are displayed preferably below content of the current page of the electronic publication.

Referring to FIGS. 1 and 2, the system enables the user to further rate and block member third-party websites. Rating member websites results in the supplemental sections being displayed in accordance with the rating of the respective member websites. More particularly, the supplemental sections pertaining to the top-rated member websites are displayed first followed by the supplemental sections pertaining to the member websites, the ratings of whom are lower than those of the earlier supplemental sections. Blocking a member website results in cutting off any communication between said member website and the parsing module 24.

Referring to FIGS. 1 and 2, in one embodiment, the input module 22 is configured to receive multiple selectable words at once. In this embodiment, the input module 22 comprises an input field accessible via the user interface 12 wherein, the input field is adapted to receive a portion of the textual content of the electronic publication or the supplemental section. Once received, multiple selectable words are selected by employing techniques such as, tapping, clicking, long-pressing, etc., each selectable word depending on the user terminal employed. The selected multiple selectable words are then received by the parsing module 24, which parses the plurality of supplemental databases 16 for matches. The retrieval module 26 retrieves the matched supplemental sections from the supplemental database 16 and compiled as enabled by the compilation module 28. Once compiled, the display module 30 displays the results (i.e., the multiple compound sections) on a new page, tab, pane, or the like. The user is further enabled to repeat the same process all over by inputting the textual content from the results (i.e., the multiple compound sections) into the input field. This results in another new set of multiple compound sections being displayed on a new tab, page, pane, or the like, in accordance with the selected selectable words.

Referring to FIGS. 1 and 2, the system further comprises a registration module (not shown) for enabling a user to register therewith whereby, the user's interaction and history therewith is saved for later retrieval. For example, the registered user's edits to the supplemental sections, his or her preferences with respect to the member websites, etc., are saved for later retrieval. The system further comprises a user database (not shown) listed a plurality of registered users. The user database is adapted to be accessible to a registered user. The system further comprises a follow module 32 comprising an exemplary “follow” button associated with each registered fellow user. Selecting the follow button results in following the said fellow user whereby, the supplemental sections that are added, edited, favorited and prioritized by the fellow user are shared with the user within the corresponding compound sections. This feature is especially appropriate in the event of the followed registered user being a teacher and the following registered user being a student of said teacher. This helps in students understanding the selectable words better and in the way the teacher would want them to understand thereby saving time and effort. In one embodiment, each electronic publication comprises a list of selectable words displayed in an alphabetical order. This helps the user to easily revise the terminology used in the corresponding electronic publication. Notably, preferably, the electronic publications are available for download to a user free of charge.

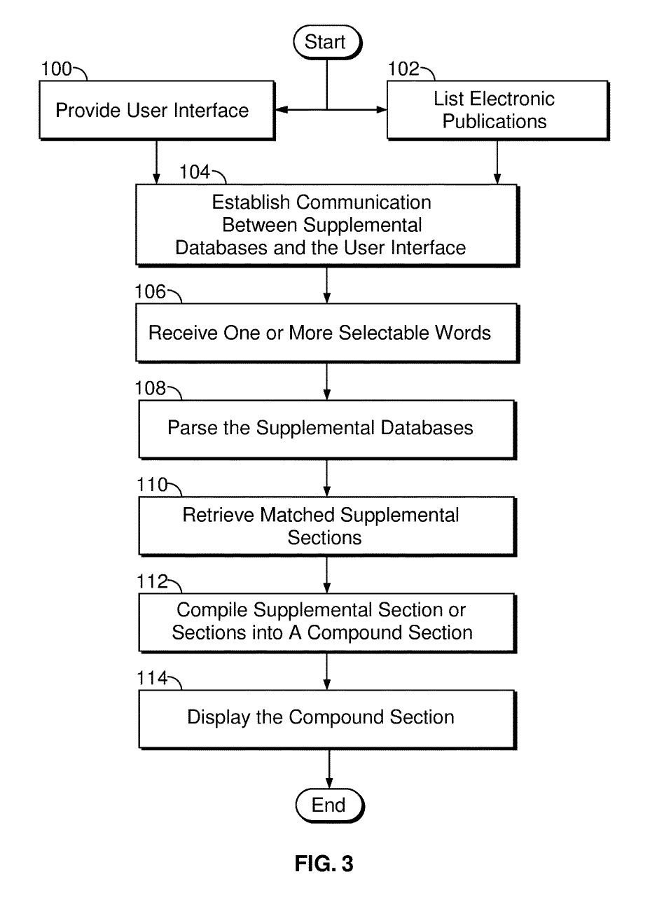

Referring to FIG. 3, the computer-implemented method of the present invention initiates with providing a user interface (step 100). The user interface is provided by a user terminal over a communications network. The method further comprises listing (step 102) a plurality of electronic publications within a main database. The method further comprises establishing (step 104) an operative communication between at least one supplemental database and the user interface. Each of the at least one supplemental database comprises a plurality of selectable words listed therewithin. More particularly, a selectable word comprises an academic term, specifically pertaining to an educational discipline, which may comprise one of various sciences, mathematics, economics, etc. Each selectable word within the supplemental database is associated with a supplemental content section (referred to as simply “supplemental section” hereinafter). The supplemental section basically comprises study material for helping a user understand the corresponding selectable word. The supplemental section comprises the definition of the selected word, one or more analogies for understanding the selectable word, one or more images representative selectable word, formula or formulae related to the selectable word, one or more graphs representative selectable word, a video or videos related to the selectable word, etc., or a combination thereof. In one embodiment, the user is enabled to search for a specific term (by selecting the same) within a field (or discipline) of science. For example, a user, via the user interface, is enabled to specify their search like, “nucleus biology function,” “icon computer definition,” etc. The user may also be enabled to search (by selecting) a word by putting noun, verb, etc., next to the word in a search bar when looking for the right definition. After searching, the part of speech could be pasted at the end of the definition in parenthesis. If a word's definition has several parts of speech, the suggestions from the search bar would list them. Notably, the textual content of the supplemental section also includes a plurality of selectable words, each of which is again associated with a supplemental section. Each supplemental database is sourced from a member external source over a communications network. More particularly, the external source comprises a third-party website wherefrom the supplemental sections are sourced. The third-party website may comprise any educational or industry website such as, Wikipedia, HowStuffWorks, Coursera, etc. More particularly, the method comprises integrating the servers of the external third-party websites with the system whereby, any updation on the third-party servers, if applicable, is reflected in the corresponding supplemental database. In one embodiment, at least one of the plurality of supplemental databases 16 comprises an offline database whereby, said offline database is accessible without data connectivity. This also helps in loading the search results quicker.

Referring to FIG. 3, the method further comprises receiving (step 106), via the user interface, one selectable word at a time. More particularly, a selectable word is received upon the user-selection of the selectable word wherein, the selection is performed by actions such as, double-clicking on the selectable word (in the event of employing a computer mouse in conjunction with the corresponding user terminal), long-pressing over the selectable word (in the event of employing a touchscreen in conjunction with the user terminal), tapping over the selectable word (in the event of employing a touchscreen in conjunction with the user terminal), etc. The method further comprises parsing (step 108) each of the at least one supplemental database for a match against the selectable word. The method further comprises retrieving (step 110) the matched supplemental sections (associated with the selected selectable word) from all the supplemental databases. The method further comprises compiling (step 112) at least one of the retrieved supplemental sections into a compound content section (referred to as simply “compound section” hereinafter). Preferably, the at least one of the retrieved supplemental sections comprises a plurality of the retrieved supplemental sections. Each supplemental section comprises a web-link for directing the user to the reference webpage of the corresponding third-party website. In the embodiment where one or more offline supplemental databases 16 are employed, no reference web-links are provided. The method further comprises displaying (step 114) the compound section over the electronic publication in an overlaying manner. Notably, the compound section is displayed closer to the selected selectable word so as not to obscure the selected selectable word.

The user is enabled to repeat the same method of generating compound section for another selectable word within a supplemental section resulting in generating another display of an appropriate compound section. Notably, in relation to obtaining compound sections by selection of selectable words from the already-displayed compound display sections, the method of obtaining compound sections can be performed any number of times on any number of prior compound sections. Notably, the compound sections are displayed such that, they do not obscure each other and the parent selectable word.

A “more” supporting method initiates with receiving the user-selection of an exemplary “more” hyperlink or button, which is associated with a compound section. The “more” supporting method end with directing the user to a new tab, pane, page, or the like, whereon the supplemental sections sourced from all the supplemental databases are displayed. A “next” supporting method initiates with receiving the user-selection of an exemplary “next” button, which is associated with a compound section. The “next” supporting method ends with displaying the next one or more supplemental sections on the compound section. A “previous” supporting method initiates with receiving the user-selection of an exemplary “previous” button, which is associated with a compound section. The “previous” supporting method ends with displaying the previously viewed one or more supplemental sections on the compound section.

An “edit” supporting method initiates with receiving the user-selection of an exemplary “edit” button, which is associated with each of the at least one supplemental section of a compound section. The “edit” supporting method further comprises allowing the user to edit the corresponding supplemental section. The “edit” supporting method, in one embodiment, ends with displaying the edited supplemental section first within a compound section. An “undo” supporting method initiates with receiving the user-selection of an exemplary “undo” button, which is associated with an edited supplemental section displayed within a compound section. The “undo” supporting method ends with reversing the edited supplemental section to its original content. An “add” supporting method initiates with receiving the user-selection of an exemplary “add” button, which is associated with a compound section. The “add” supporting method further comprises delivering an input field for receiving the user's custom composed supplemental section. The “add” supporting method, in one embodiment, ends with displaying the added supplemental section first within a compound section. In one embodiment, a “font” supporting method initiates with the input of a user-selection of a font (selected from a list of selectable fonts). Thereafter, the method comprises replacing the original font of the textual content pertaining to the supplemental section with the selected font.

An “attach” supporting method initiates with receiving the user-selection of an exemplary “attach” button, which is associated with each of the at least one supplemental section of a compound section. The “attach” supporting method further comprises prompting a user to select an image(s) or a video(s). The “attach” supporting method ends with uploading the selected image(s) and video(s) whereby, the attached content acts as supporting content for the corresponding supplemental section. In one embodiment, a “URL” supporting method initiates with receiving the user-selection of an exemplary “URL” button, which is associated with each of the at least one supplemental section of a compound section. The “URL” supporting method further comprises prompting a user to input one or more URLs, each of which pertaining to a YouTube video. The “URL” supporting method ends with publishing the links of the corresponding YouTube videos along with the corresponding supplemental section. The published YouTube link or links act as supporting content for the corresponding supplemental section.

A “prioritization” supporting method, in the event of the compound section displaying a plurality of supplemental sections, initiates with associating each of the plurality of supplemental sections within a compound section with exemplary prioritization buttons or checkboxes wherein, each of which represents a degree of prioritization. The “prioritization” supporting method further comprises receiving the user's multi-selection of a “prioritization” buttons for each of the plurality of supplemental sections. The “prioritization” supporting method ends with arranging the order of the supplemental sections in accordance with the degree of priority assigned thereto. In one embodiment, the “prioritization” supporting method comprises employing color-coding for better user-recognition wherein, each color represents a degree of priority. For example, the color red might represent high priority, orange might represent medium priority and yellow, low priority. In this embodiment, the “prioritization” supporting method further comprises filling in the supplemental section with the chosen color and arranging the colored supplemental sections in the order the degree of priority.

A “rate” supporting method initiates with providing a means that enable a user to rate a third-party member website. The “rate” supporting method further comprises receiving the user-selection of ratings awarded to the third-party websites. The “rate” supporting method further comprises arranging the display order of the supplemental sections in accordance with the ratings of the respective member websites thereof. More particularly, the “rate” supporting method comprises displaying the supplemental sections pertaining to the top-rated member websites first followed by displaying the supplemental sections pertaining to the member websites, the ratings of whom are lower than those of the earlier supplemental sections. A “block” supporting method initiates with providing a means that enable a user to block a third-party member website. The “block” supporting method further comprises receiving the user-selection of an exemplary “block” button associated with a third-party website. The “block” supporting method ends with blocking data transactions between said member website and the user interface.

In an additional embodiment, the additional method of the present invention comprises receiving a portion of the textual content pertaining to the electronic publication or the supplemental section wherein, the textual content comprises a plurality of selectable words. The additional method further comprises receiving the user-selection of multiple selectable words. More particularly, the multiple selectable words are received by employing techniques such as, tapping, clicking, long-pressing, etc., each selectable word depending on the user terminal employed. The additional method further comprises parsing the plurality of supplemental databases for matches against the selected multiple selectable words. The additional method further comprises retrieving the matched supplemental sections from the supplemental databases and compiling the same. The additional method further comprises displaying the compiled results on a new tab, page, pane, or the like.

A registration method initiates with delivering a registration form to a user for receiving valid registration details therewithin. Upon receiving valid registration details, the registration method further comprises treating the user as a registered user by delivering access details such as, a username, password, etc. Upon registration, the user interactions such as supplemental section edits, newly composed supplemental sections, prioritized supplemental sections, color-coded supplemental sections, rating and blocking preferences of member websites, etc., are saved for later retrieval.

The “follow” supporting method initiates with listing a plurality of registered users within a user database. The user database is adapted to be accessible to a registered user. The “follow” supporting method further comprises receiving the user-selection of an exemplary “follow” button, which is associated with each registered fellow user. The “follow” supporting method further comprises sharing the fellow users' supplemental sections that are added, edited, favorited and prioritized with the user upon the user selecting the appropriate selectable words. This feature is especially appropriate in the event of the followed registered user being a teacher and the following registered user being a student of said teacher. This helps in students understanding the selectable words better and in the way the teacher would want them to understand thereby saving time and effort. Notably, in one embodiment, in the event of there being only one supplemental section for a selectable word, the functions associated with the corresponding compound and supplemental sections (such as, the “more,” “next,” “previous,” “favorite,” prioritization, etc., buttons, are rendered non-functional or ‘grayed-out.’ In one embodiment, a “history” supporting method includes displaying last-accessed one or more supplemental sections in the current page of the electronic publication. More particularly, the last-accessed supplemental section or sections are displayed preferably below content pertaining to the current page of the electronic publication.

The aforementioned embodiments are able to be implemented, for example, using a machine-readable medium or article which is able to store an instruction or a set of instructions that, if executed by a machine, cause the machine to perform a method and/or operations described herein. Such machine is able to include, for example, any suitable processing platform, computing platform, computing device, processing device, electronic device, electronic system, computing system, processing system, computer, processor, or the like, and is able to be implemented using any suitable combination of hardware and/or software. The machine-readable medium or article is able to include, for example, any suitable type of memory section, memory device, memory article, memory medium, storage device, storage article, storage medium and/or storage section; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions is able to include any suitable type of code, for example, source code, compiled code, interpreted code, executable code, static code, dynamic code, or the like, and is able to be implemented using any suitable high-level, low-level, object-oriented, visual, compiled and/or interpreted programming language, e.g., C, C++, Java, BASIC, Pascal, Fortran, Cobol, assembly language, machine code, or the like. Functions, operations, components and/or features described herein with reference to one or more embodiments, is able to be combined with, or is able to be utilized in combination with, one or more other functions, operations, components and/or features described herein with reference to one or more other embodiments, or vice versa.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A computer-implemented system comprising:
(a) a main database comprising a plurality of electronic publications listed therewithin;
(b) a user interface for enabling a user to interact therewith, the user interface for enabling the selection and display of an electronic publication, each electronic publication comprising a multiplicity of selectable words, each of which associated with a supplemental content section, the supplemental section in turn comprising a plurality of selectable words, each of which again associated with a supplemental section;
(c) at least one supplemental database listed with a multiplicity of selectable words, each of which associated with a supplemental section;
(d) an input module for receiving at least one selectable word selected via the user interface;
(e) a parsing module for parsing each of the at least one supplemental database for a match against each of the at least one selectable word;
(f) a retrieval module for, upon match, retrieving a supplemental section from each of the at least one supplemental database; and
(g) a display module for displaying a compound content section within the electronic publication, the compound section comprising the retrieved supplemental section or sections.

2. The system of claim 1 wherein, the electronic publication comprises one of an e-book, an online news piece and an online article.

3. The system of claim 1 wherein, each of the at least one supplemental database is sourced from a member third-party source.

4. The system of claim 3 wherein, the third-party source comprises a third-party website.

5. The system of claim 4 wherein, each supplemental section comprises a web-link for directing a user to the webpage of the corresponding third-party website where the supplemental content is located.

6. The system of claim 3 wherein, the third-party sources are user-rated.

7. The system of claim 6 wherein, in the event of the compound section comprising more than one supplemental section, the compound section is displayed such that, the supplemental sections, the corresponding third-party sources of which are top-rated, are displayed first.

8. The system of claim 1 wherein, the supplemental section comprises at least one of: the definition of the selected word, one or more analogies for understanding the selected word, one or more images representative selected word, one or more graphs representative selected word and one or more videos related to the selected word.

9. The system of claim 1 wherein, the compound section comprises one supplemental section.

10. The system of claim 1 wherein, the compound section comprises more than one supplemental section.

11. The system of claim 10 further comprising a compilation module for compiling a plurality of supplemental sections into a compound section before the being displayed by the display module.

12. The system of claim 10 wherein, the user interface is configured to display all supplemental sections on a different page, tab, pane, or the like, other than that of the corresponding electronic publication upon the user-selection of an appropriate link on the corresponding compound section.

13. The system of claim 1 wherein, in the event of the compound section comprising a plurality of supplemental sections, the supplemental sections, via the user interface, are adapted to be prioritized, whereby the supplemental sections are displayed within the compound section in accordance with the degree of priority assigned thereto.

14. The system of claim 13 wherein, the prioritized supplemental sections are color-coded whereby, a color represents a degree of priority.

15. The system of claim 14 wherein, the prioritized supplemental sections are saved for later retrieval.

16. The system of claim 1 wherein, the at least one supplemental database comprises a plurality of supplemental databases.

17. The system of claim 1 wherein, the input module is configured to receive one selectable word at a time.

18. The system of claim 1 wherein, the input module is configured to receive multiple selectable words at a time.

19. The system of claim 1 wherein, the user interface is configured to display the last-accessed one or more supplemental sections on the current page of the corresponding electronic publication.

20. The system of claim 1 wherein, via the user interface, the textual content pertaining to a supplemental section is editable.

21. The system of claim 20 configured such that, the edited supplemental section is reversible to original supplemental section.

22. The system of claim 20 configured such that, the display module displays the edited supplemental section first.

23. The system of claim 20 wherein, the edited supplemental section is saved for later retrieval.

24. The system of claim 20 further comprising a follow module comprising:
(a) a user database comprising a plurality of users listed therewithin; and
(b) a selection module for enabling a user, via the user interface, to parse the user database for one or more fellow users therefrom;
each fellow user associated with an exemplary ‘follow’ link, which when selected by the user via the user interface, the supplemental section or sections that are edited by the fellow user are accessible to the user upon the selection of the corresponding selectable words by the user as enabled by the input module via the user interface.

25. The system of claim 1 wherein, the compound section, upon the selection of the corresponding selectable word, is overlaid on the electronic publication.

26. The system of claim 1 wherein, at least one of the at least one supplemental database comprises an offline database.

27. A computer-implemented method comprising:
(a) providing a user interface;
(b) listing a plurality of electronic publications within a main database, each electronic publication comprising a multiplicity of selectable words, each of which associated with a supplemental content section, the supplemental section in turn comprising a plurality of selectable words, each of which again associated with a supplemental section;
(c) establishing an operative communication between at least one supplemental database and the user interface, each of the at least one supplemental database listed with a multiplicity of selectable words, each of which associated with a supplemental section;
(d) via the user interface, receiving at least one selectable word selected;
(e) parsing each of the at least one supplemental database for a match against each of the at least one selectable word;
(f) upon match, retrieving a supplemental section from each of the at least one supplemental database; and
(g) displaying a compound content section within the electronic publication, the compound section comprising the retrieved supplemental section or sections.

28. The method of claim 27 wherein, the electronic publication comprises one of an e-book, an online news piece and an online article.

29. The method of claim 27 wherein, each of the at least one supplemental database is sourced from a third-party source.

30. The method of claim 29 wherein, the third-party source comprises a third-party website.

31. The method of claim 30 wherein, each supplemental section comprises a web-link for directing a user to the webpage of the third-party website where the supplemental content is located.

32. The method of claim 29 wherein, the third-party sources are user-rated.

33. The method of claim 32 wherein, in the event of the compound section comprising a plurality of supplemental sections, the compound section is displayed such that, the supplemental sections, the corresponding third-party sources of which are top-rated, are displayed first.

34. The method of claim 27 wherein, the supplemental section comprises at least one of: the definition of the selected word, one or more analogies for understanding the selected word, one or more images representative selected word, one or more graphs representative selected word and a video related to the selected word.

35. The method of claim 27 wherein, the compound section comprises one supplemental section.

36. The method of claim 27 wherein, the compound section comprises a plurality of supplemental sections.

37. The method of claim 36 further comprising compiling a plurality of supplemental sections into a compound section before the being displayed by the display module.

38. The method of claim 36 wherein, the user interface is configured to display all supplemental sections on a different page, tab, pane, or the like, other than that of the corresponding electronic publication upon the user-selection of an appropriate link on the corresponding compound section.

39. The method of claim 27 further comprising, in the event of the compound section comprising a plurality of supplemental sections, prioritizing the supplemental sections whereby, the supplemental sections are displayed within the compound section in accordance with the degree of priority assigned thereto.

40. The method of claim 39 further comprising color-coding the prioritized supplemental sections are color-coded whereby, each color represents a degree of priority.

41. The method of claim 40 further comprising saving the prioritized supplemental sections for later retrieval.

42. The method of claim 27 wherein, the at least one supplemental database comprises a plurality of supplemental databases.

43. The method of claim 27 further comprising receiving one selectable word at a time before parsing.

44. The method of claim 27 further comprising receiving multiple selectable words at a time before parsing.

45. The method of claim 27 wherein, the user interface is configured to display the last-accessed one or more supplemental sections on the current page of the corresponding electronic publication.

46. The method of claim 27 further comprising editing the textual content pertaining to the supplemental section via the user interface.

47. The method of claim 46 further comprising reversing the edited supplemental section into the original supplemental section.

48. The method of claim 46 further comprising displaying the edited supplemental section first.

49. The method of claim 46 further comprising saving the edited supplemental section for later retrieval.

50. The method of claim 46 further comprising listing a plurality of users within a user database, each user associated with an exemplary ‘follow’ link, which when selected by the user, the supplemental section or sections edited by the fellow user are accessible to the user upon the selection of the corresponding selectable words by the user via the user interface.

51. The method of claim 27 further comprising overlaying the compound section over the electronic publication upon the user-selection of the corresponding selectable word.

52. The method of claim 27 wherein, at least one of the at least one supplemental database comprises an offline database.
